(19) United States
(12) Patent Application Publication
(10) Pub. No.: US 2015/0208615 A1
(43) Pub. Date: Jul. 30, 2015

(54) Remote Controlled Pet Collar Illumination

(71) Applicant: K&B Patent Holdings, LLC, Boulder, CO (US)

(72) Inventors: Kurtis Scott Reindl, Boulder, CO (US); Benjamin Alan Anderson, Boulder, CO (US)

(73) Assignee: K&B PATENT HOLDINGS, LLC, Boulder, CO (US)

(21) Appl. No.: 14/604,596

(22) Filed: Jan. 23, 2015

Related U.S. Application Data
(60) Provisional application No. 61/931,276, filed on Jan. 24, 2014.

(51) Int. Cl. A01K 27/00; H05B 37/02

(52) U.S. Cl. CPC A01K 27/006; A01K 27/001; H05B 37/0272

(57) ABSTRACT

A pet animal collar comprises a processor unit configured to effect illumination patterns comprising a combination of color and blink for an array of light sources on the collar. A memory unit coupled to the processor stores multiple illumination patterns, and a radio receiver unit provides wireless remote access to the processor unit to enable uploading and/or selecting at least one of illumination patterns. In some aspects, the processor unit responds to sensor signals from a sensor unit (such as an accelerometer) on the collar to select or change a displayed illumination pattern. A computer program product includes a non-transitory computer readable medium storing software instructions that cause the processor unit to control and adapt the illumination patterns.

### CROSS-REFERENCE TO RELATED APPLICATIONS

This application claims priority under 35 U.S.C. 119(e) to U.S. Provisional Application Ser. No. 61/931,276, entitled “Remote Controlled Pet Collar Illumination,” filed Jan. 24, 2014.

### BACKGROUND

1. Field of the Invention

Subject matter disclosed herein relates generally to apparatuses and methods for tracking pet animals, and, more particularly for tracking of pet animals, such as dogs and cats, and doing so using a specially designed collar.

2. Background

The background description includes information that may be useful in understanding the present inventive subject matter. It is not an admission that any of the information provided herein is prior art or relevant to the presently claimed inventive subject matter, or that any publication specifically or implicitly referenced is prior art.

Basic animal collars are often used for identifying a pet animal and the owner's information. However, collars are less than effective for locating the animal in low-light conditions. More advanced means of tracking stray animals include subcutaneously imbedded identification chips, which allow authorities to identify the animal and its owners without a collar being present. More advanced collar devices include radio communications, which may provide proximity or location information of the animal. Some advanced collars include embedded Global Positioning System (GPS) connectivity for locating the animal over greater distances. These advanced collars also include the animal and owner identifying information to be electronically stored and retrieved after the animal is found.

Some applications of tracking collars relate to hunters and hunting activities. During a hunting expedition, a hunting dog may be employed to track, retrieve, or flush out target prey. Coordination between the dog and the hunter is a critical factor in the ability to facilitate these activities.

Advanced tracking collars are usually paired with a handheld display, which may be a cellular phone, configured to display proximity, coordinates, or tracking data overlaid on a map. When multiple animals are being tracked, it is often necessary to visually distinguish between the animals, which can be difficult in low-light conditions. While illuminated collars are useful for tracking animals at night, it is challenging to visually differentiate between animals wearing similar collars. This is particularly problematic at dog parks where dogs belonging to different owners are roaming and where dogs tend to be less responsive to verbal commands. In such cases, being able to visually differentiate animals is far more useful than trying to locate an animal via a graphical display on a handheld device.

### SUMMARY

In one aspect of the disclosure, a pet animal collar comprises a processor unit configured to effect illumination patterns comprising a combination of color and blink for an array of light sources on the collar. A memory unit coupled to the processor stores multiple illumination patterns, and a radio receiver unit provides a user with wireless remote access to the processor unit for uploading and/or selecting at least one of illumination patterns.

In another aspect of the disclosure, a method provides for effecting illumination patterns comprising a combination of color and blink for an array of light sources on a pet animal collar, storing at least one illumination pattern in a computer-readable memory, and enabling wireless remote access to the memory such that a user can select an illumination pattern.

A computer program product includes a non-transitory computer readable medium storing software instructions that causes a processor to execute steps of the methods disclosed herein.

In some aspects of the disclosure, the processor unit responds to sensor signals from a sensor unit (such as an accelerometer) on the collar to select or change a displayed illumination pattern.

Various objects, features, aspects, and advantages of the claimed subject matter will become more apparent from the following detailed description, along with the accompanying drawing figures in which like numerals represent like components.

### BRIEF DESCRIPTION OF THE DRAWINGS

The principles and operation of a method and apparatus for a pet animal collar for tracking may be better understood with reference to the drawings and the accompanying description. Flow charts depicting disclosed methods comprise “processing blocks” or “steps” may represent computer software instructions or groups of instructions. Alternatively, the processing blocks or steps may represent steps performed by functionally equivalent circuits, such as a digital signal processor or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present disclosure. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied. Unless otherwise stated, the steps described below are unordered, meaning that the steps can be performed in any convenient or desirable order.

FIG. 1A is a perspective view of a device configured in accordance with aspects of the invention.

FIG. 1B, is a perspective view of an animal tracking collar in accordance with another aspect of the invention.

FIG. 2 is a block diagram of electronic components on a collar according to an aspect of the invention.

FIG. 3 is a flow diagram of a method configured in accordance with one aspect of the invention.

FIG. 4 is a flow diagram of a method configured in accordance with another aspect of the invention.

FIG. 5 depicts software modules configured in accordance to an aspect of the invention.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Subject matter in the disclosure generally provides a collar for pet animals such as dogs and cats. The collar comprises a light display that can be activated remotely via a remote wireless communication device, such as to select display patterns comprising a combination of colors, blink, and illumination levels. The collar also comprises a processor (such as a microprocessor) with memory storage that can store display patterns and provide other processing and control parameters. In some aspects of the invention, the memory is configured to store data and software instructions in support of executing a computational function, such as depicted in flow diagrams referenced in the disclosure. Contemplated memory includes RAM, Flash, magnetic storage, solid state drives, race track memory, or other forms of data storage.

In accordance with aspects of the disclosure, the collar comprises a one-way or two-way communication device attached or integrated thereto that couples to the processor. This allows the user to activate and control functions of the microprocessor. In some aspects of the invention, the processor may provide the user with status information about the collar's operation, such as battery life and which pattern is being displayed. In other aspects, sensor data may be collected by the microprocessor and stored and/or transmitted to the remote wireless communication device. For example, an accelerometer and/or one or more other sensor elements may be attached to or embedded in the band of the collar to gather data that can be processed on the collar itself and/or transmitted to a remote terminal, such as a home computer, a hand-held device, or a main server computer. In some aspects of the invention, the collar's processor and communication device may be configured to search for and connect to open Wi-Fi networks. Information about Wi-Fi networks, such as the IP address of an access point, may be stored and transmitted to a remote terminal, such as to help a pet owner locate a lost pet based on geographical information associated with the IP address. In such aspects, the processor can be configured to call a geo-location function that searches a geo-location database in which IP addresses are mapped to geographic locations, such as street addresses. Upon determining the geographic location of one or more networks, the location may be transmitted to the user, such as via email, text message, telephone call, radio signal, etc. In some aspects, the location data may be overlaid on a map. For example, multiple data points can be used to determine a precise location. Also, when multiple data points are collected over time and mapped, this can track the pet animal.

In some aspects of the invention, the processor collects activity information about the pet, which can be used to calculate physiological parameters, such as calories burned. Such information may be stored locally, uploaded to a database, and/or transmitted in real time to the user.

One aspect of the present invention provides for the coordination of the present collar microprocessor with a user computing device, such as a smart phone, tablet, or personal computer, which contains a software application that controls the operation of the device. This includes tracking initiation, light source control, communication links, and associated tools for desired operation of the collar during a specific event or scenario. Direct control of the collar elements may be provided via user interface controls on the collar, or in conjunction with wireless inputs from such a program, wherein the inputs are relayed over a wireless network. This provides a collar with adaptable and user friendly controls, which can be provided to facilitate identifying, tracking, and monitoring a target animal.

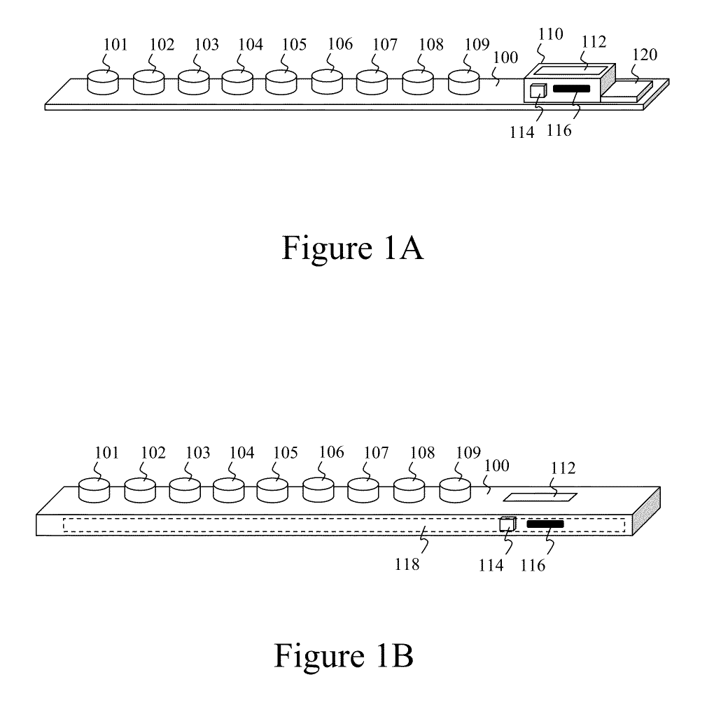

FIG. 1A is a perspective view of a device configured in accordance with aspects of the invention. The device is a collar style accessory configured to removably fasten around the neck of an animal when in use. The device comprises a collar band 100, a plurality of light sources 101-109, an electronics housing 110, and a wireless communications transceiver 120.

Various materials may be used in the construction of the device. For example, the collar band 100 may be leather, rubber, web material, nylon, or other material commonly used in the construction of animal collars. The collar band 100 may comprise fasteners (not shown) disposed at opposing ends. These fasteners mate together to bring the band into an encircling collar shape. In one aspect of the invention, the collar band 100 may comprise electrically conductive connectors, such as electrical wiring encased within for electrically connecting the light sources 101-109 to the electronics housing 110. The collar, while serving as a means of location and identification, may also facilitate attachment of a leash, which enables the device to function as a standard animal collar for use with dogs or similar pets.

In another aspect of the invention, the collar may be adapted for use as a leash extender. For example, the collar's fasteners may comprise a first fastener configured to attach to a standard animal collar, and a second fastener configured to attach to a leash. This enables the collar's light sources 101-109 to illuminate an area around a leashed pet without requiring the device to be worn as a collar.

In aspects of the invention, the light sources 101-109 may be arranged so as to occupy a substantial percentage of the area generally defined by the outer surface of the collar 100. The light sources 101-109 may comprise digital lighting technologies (i.e. semiconductor light sources), such as light-emitting diodes (LEDs). Functional advantages and benefits of LEDs include low power consumption with high optical efficiency, durability, lower cost, and many others.

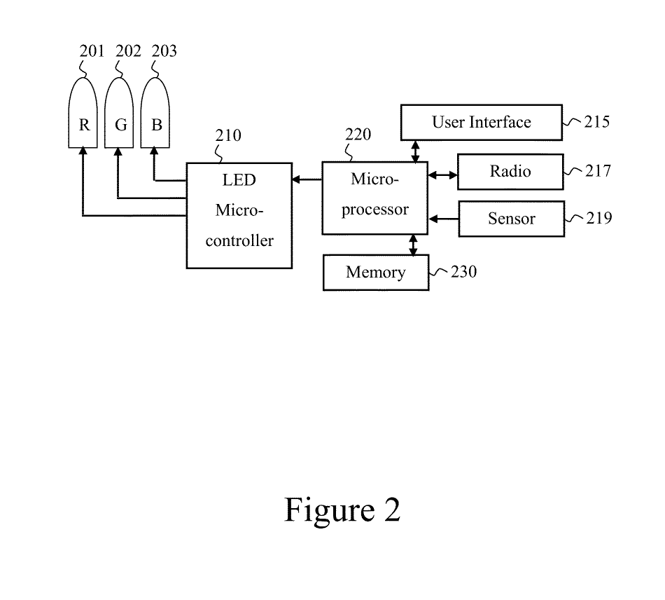

Some aspects of the invention employ programmable color LEDs. For example, in FIG. 2, a multi-color LED contains red, green, and blue elements (such as elements 201, 201, and 203, respectively) that can be mixed to produce any color. A microcontroller 210 controls each multi-color LED by separately controlling each of its component elements 201, 201, and 203, such as to provide fade and blink. Each LED can be addressed individually in software, enabling it to display different animations. In accordance with some aspects, a user can select from a set of pre-programmed patterns. In some aspects, a user can program the microcontroller 210 to generate customized patterns. In some aspects, a user can program the microcontroller to display animations in response to sensor inputs from sensors on the collar.

In accordance with some aspects of the disclosure, the device allows a user to control the operation of the collar by dialing a preset phone number (or otherwise interfacing with the radio system 217), which activates communication and other actions on the collar. For example, with respect to methods disclosed herein, the radio system 217 can provide an interface with the microprocessor 220, such as to allow the user to select a preprogrammed illumination pattern to be used by the LED micro-controller 210, to upload an illumination pattern to the memory 230, to adjust an illumination pattern in use, to delete a pattern, as well as provide for other command and control functions. The radio system 217 can also allow the user to control sensor outputs and/or receive sensor data, including sensor data processed by the microcontroller 210.

The electronics housing 110 provides space for electronic controller elements of the device, such as the LED microcontroller 210, microprocessor 220, memory 230, and a battery power supply (not shown). The memory 230 provides for storing LED patterns, and the memory storage may be accessible by both the LED microcontroller 210 and the microprocessor 220. The memory storage 230 can be a flash memory or other memory storage devices known in the art. In one aspect of the invention, the microprocessor 220 is communicatively coupled to a user interface 215, a radio system 217, and at least one sensor 219 (such as an accelerometer) mounted on the collar.

The electronics housing 110 may comprise a display area 114 as part of a user interface 215. An external user input may be provided on the housing 110, such as a depressible button 114 or plurality thereof so that the display screen 114 may be cycled through various screens for options to be chosen during deployment of the device. These options may include operation of the light sources, highlighting the display screen, and controlling operation of the wireless communications transceiver 120. The microprocessor and or memory storage may be detachable from the collar for direct connection to a computer terminal, such as to enable faster or more secure uploading and/or downloading of data.

The housing 110 comprises an electrical power input and data connection 116, such as a Universal Serial Bus (USB) connection, which allows connection to a personal computer or handheld wireless device, and provides for charging the internal power supply (not shown). The USB connection 116 allows data to be uploaded onto the memory of the device, such as user operation options selection and preferences, LED patterns for use by the LED microcontroller, and operation options for the wireless communications transceiver 120. In some aspects of the invention, a GPS device may be incorporated into collar 100. The GPS device may take the form, for example, of an integrated circuit or an RFID. Other location awareness technology may also be incorporated into the collar 100. In some aspects, the housing 110 may comprise one or more sensors, such as an accelerometer (not shown).

The wireless communications transceiver 120, which may be attached to or incorporated into the collar, may comprise a smart phone, mobile (and/or hand-held) device, or any other communication/messaging device, or a specifically designed transceiver. The wireless communications transceiver 120 may comprise one or more wireless transceivers configured in accordance with one or more wireless technologies, including, but not limited to Wi-Fi, cellular, UHF, BlueTooth, Wireless USB, and UWB personal area network technologies. Longer-range technologies, such as cellular, UHF, and Wi-Fi may be used for remote tracking, while shorter-range technologies, such as BlueTooth, Wireless USB, and UWB personal area network, may be employed for data uploads and/or downloads.

Referring now to FIG. 1B, there is shown a perspective view of an animal tracking collar in accordance with another aspect of the invention. The collar 100 comprises an elongated band adapted to encircle the neck of an animal in a similar fashion as most dog collars present in the art. The collar 100 employs several embedded features that facilitate tracking of the collar location, and further allow an owner to directly communicate with the collar. The collar 100 comprises a central interior cavity 118 within which a plurality of electronic elements (not shown) are located, along with necessary electrical and data routing wiring (not shown). Within the interior cavity 118 is stored the internal electric components necessary for operation of the present device. The most notable of those components is a memory, wireless communication transceiver, power supply, LED microcontroller, and a microprocessor having programmable logic to coordinate the electrical elements of the device and facilitate their function through received inputs. Also provided along the collar are a plurality of LED light sources 101-109, a collar control display screen 112, a user interface control 114, and an electrical power input and data connection 116. The electronic devices work together to facilitate tracking features.

The microprocessor is a programmable electronic device that interprets electrical signals from the various electronic components within the collar to allow for several operating modes and collar functions during deployment. Along with the microprocessor is computer memory in which to store preprogrammed and user-generated lighting patterns, along with all embedded code necessary for operation of the system.

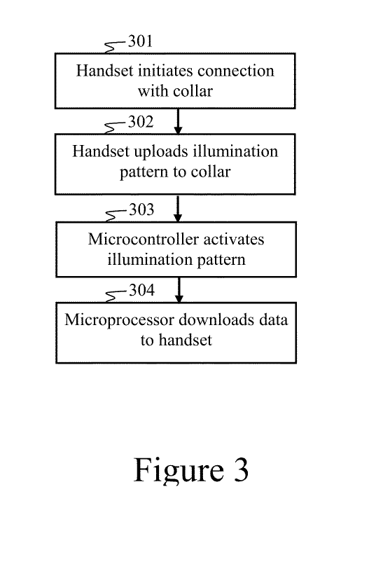

FIG. 3 is a flow diagram of a method configured in accordance with one aspect of the invention. The collar operation initiates 301 with a cellular phone call or Wi-Fi contact from the user's wireless handset to a preset identifier number associated with the collar. In one aspect, the call is transmitted over a third-party network (e.g., a cellular network, or the Internet) and is processed by the collar to initiate communications between the user operating the wireless handset and the animal wearing the collar. In an alternate aspect, the communication employs a direct wireless link (e.g., a peer-to-peer link) between the handset and the collar. While the communication link is active, the user can operate various features on the collar, including activating 303 the light sources 101-109, uploading 302 data to the collar, and downloading 304 data from the collar.

Functions of the collar may be initiated remotely, wherein keypad inputs can initiate certain actions, such as operation of the light sources 101-109, initiating a data upload to the collar, or requesting a data download from the collar. In some aspects of the invention, the light sources 101-109 can be switched on when the user initiates wireless connectivity 301, wherein the lights automatically engage or when a keypad option is chosen during the connection. In one aspect of the invention, the user uploads 302 a new light pattern to be displayed by the collar. For example, at a dog park, when multiple animals are wearing illuminated collars in low-light conditions, it can be difficult for a pet owner to distinguish between the animals. By instructing the collar to display a unique lighting pattern (e.g., color and or flashing), the pet owner can distinguish their animal from others. It is anticipated that the lighting pattern can comprise various combinations of color and blinking, and such patterns can comprise animations.

The microcontroller initiates a lighting pattern 303 in response to user input and/or in response to one or more sensor signals. For example, a photodiode sensor may provide a low-light indicator signal to the microprocessor, which then instructs the microcontroller to illuminate the light sources 101-109. In some aspects, a movement sensor, such as an accelerometer, may provide input signals to the microprocessor, which may be programmed to display one or more predetermined patterns based on the inputs. In one aspect, the collar may be illuminated based on the distance of the collar from the handset. For example, the microprocessor may be responsive to wireless signal strength, GPS data, wireless ranging data, etc. In some aspects of the invention, the cellular network is utilized to track the collar by way of tracking the wireless transceiver's cellular output signal angle of approach to a nearby cell tower, length of time it takes the outgoing signal to travel to multiple towers, and the strength of the signal when it reaches the towers. These variables can each be utilized to track or triangulate the position of the collar without the use of the GPS. In the event of the collar exiting a usable cellular network, the wireless transceiver may search for an open Wi-Fi network.

In aspects of the invention, the microprocessor is configured to download 304 data to the handset upon interrogation, upon receiving predetermined sensor inputs, and/or at predetermined intervals. The microprocessor may employ any of various communication modes, including email communication and SMS notification. In accordance with one aspect of the invention, the microprocessor may be programmed to be responsive to sensor inputs (such as wireless signal strength, GPS data, etc.) that indicate that the animal may be lost. The microprocessor may respond by probing for Wi-Fi access points, and storing the IP address of each access point it finds. The IP addresses may be uploaded to the handset or a computer system that employs an IP address locator to determine the geographical location of the animal. In another aspect of the invention, as will be described below, pedometer data may be downloaded from the collar. The pedometer data may be used for activity monitoring and/or measurement, as well as for locating a lost animal.

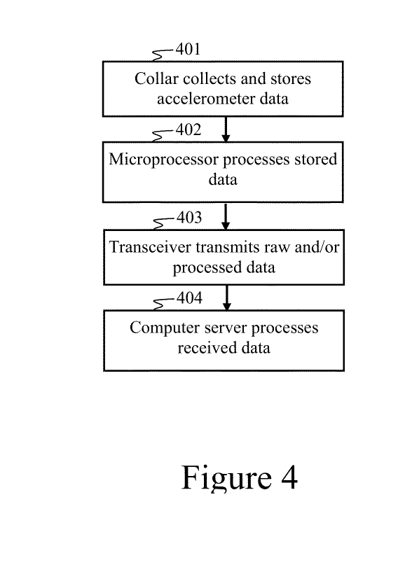

FIG. 4 is a flow diagram illustrating methods in accordance with some aspects of the invention. In one aspect, the collars shown in FIGS. 1 and 2 may also include electronic gyroscopes and accelerometers which produce signals that can be processed to determine the current angular and linear acceleration, and in turn, and in conjunction with location information derived from a GPS signal, velocity and relative displacement of the device.

The microprocessor may be configured to collect and store 401 signals representing data sensed by one or more of the sensor elements (not shown) and may be configured to analyze 402 the data and communicate 403 processed and/or raw data to a wireless communications system. In some aspects, the microprocessor may execute algorithms to interpret a collection of the data sensed by sensor elements and produce a summary of the collected data.

The data may include physiological data, such as data about the movement of the pet animal, since this physiological data, when combined with location information may be useful in determining the location of a lost animal. Accelerometer and positioning data enables the microprocessor to produce real-time data of the animal's speed, distance travelled, etc. This data may optionally be stored on such devices such that it can be analyzed after the animal has finished their activity, e.g. in some cases, by transferring 404 the collected data to a computer or website to be displayed on a digital map. In some aspects of the invention, a computer server may be pre-programmed to interact with the microprocessor for updating the map. Thus, if the pet owner's handset is communicatively coupled to the server, they can receive real-time updates of their pet's location and movement, as well as calorie count and duration of activity.

A computer server that receives 404 the data may gather analytical information, including statistics, trend analysis, comparative analysis, etc., regarding particular pets or particular breeds of pets. In some aspects, the computer server may provide a social network for animal owners for the purpose of sharing information.

In some aspects of the invention, the microprocessor may modify the pattern and/or color of the collar's light display 101-109 to signal to the pet owner that a predetermined analysis metric was achieved. In one aspect, the metric may indicate that the animal has performed a predetermined amount of exercise. For example, the metric may include a predetermined number of calories calculated from pedometer data. The metric may be based on a calculation of exercise duration, such as the amount of time the animal is moving above a threshold speed. In some aspects, the metric may comprise a simple timer, and the microprocessor may signal the owner via the light display 101-109 when time has expired. In some aspects, the microprocessor may signal the animal, such as via an audio signal, to instruct it to return to its owner.

It should be noted that any language directed to a computer should be read to include any suitable combination of computing devices, including servers, interfaces, systems, databases, agents, peers, engines, controllers, modules, or other types of computing devices operating individually or collectively. One should appreciate that the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

As used in the description herein and throughout the claims that follow, when a system, engine, server, device, module, or other computing element is described as configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

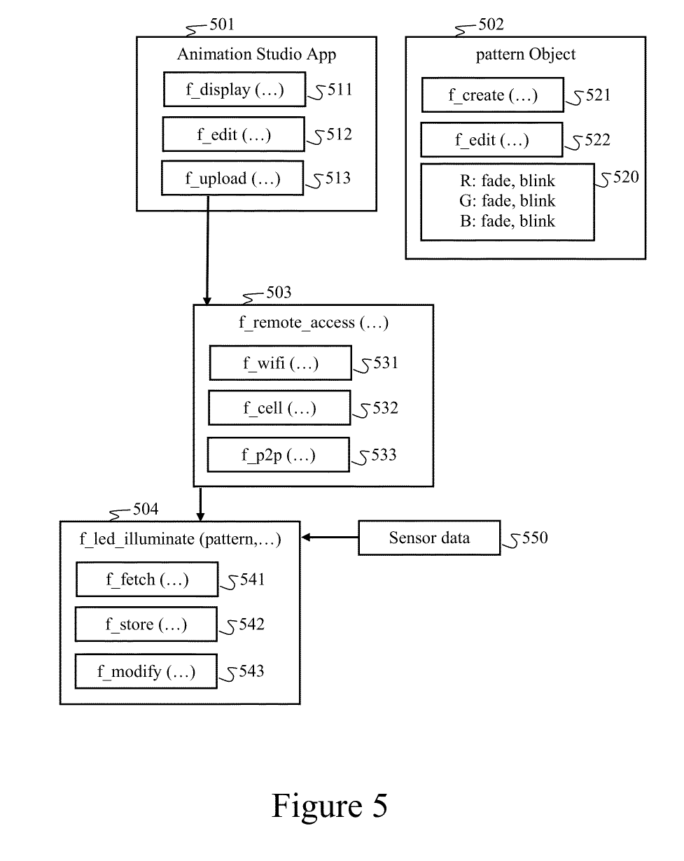

As illustrated in FIG. 5, software implemented in accordance with aspects of the invention may comprise functionality that is separable into multiple independent and interchangeable modules. In some aspects, a module may comprise a software object. In some applications, a module may comprise a container that contains other objects. While the scale of a module may vary depending on the programming language and the application, modules are typically designed to perform logically discrete functions and interact via well-defined interfaces. It should be appreciated that in some aspects of the disclosure, modules can comprise data objects, and such data objects reside in physical memory of a computing device and can comprise executable instructions stored in memory that cause a processor to execute steps that give rise to the disclosed functionality, such as described above.

In one aspect of the disclosure, software depicted in FIG. 5 provides for coordination of the collar's microprocessor with a user computing device, such as a smart phone, tablet, or personal computer. An animation studio app 501 comprises a software application residing on the user computing device that provides a graphical user interface to aid the user in viewing, selecting, creating, and editing collar illumination patterns. A collar illumination pattern can comprise a “pattern” data object 502, which can include functions (e.g., f_create 521 and f_edit 522), and module interface data 520.

The module interface 520 expresses the data and/or functional elements that are provided and required by the module 502. For example, the pattern object 502 is characterized by red (R), green (G), and blue (B) LED control parameters, which may comprise data structures and/or functions. For example, fade and blink values for each LED control parameter may comprise a data set and/or a function that expresses how fade and blink change with respect to time, or via some other parameter, such as sensor data 550. The elements defined in the interface are usually detectable by other modules.

The application 501 may comprise functions to display 511, edit 512, and upload 513 pattern objects to the microprocessor on board the collar. For example, the upload function 513 may call a remote access function 503, which activates a particular function 531-533 based on the type of connection that is available. In addition to uploading pattern objects to memory on board the collar, the upload function 513 provides the user with wireless remote access to the memory to enable selection of an illumination pattern.

The microprocessor is configured to execute LED control software, such as an LED illumination program 504 residing in memory on board the collar. The program 504 employs at least one pattern object 502 as its input. In addition to effecting illumination patterns comprising a combination of color and blink for an array of LEDs on the collar, the program 504 can fetch 541 pattern objects 502 from memory, such as in response to a user selection, store pattern objects 502 in the memory, and/or modify an illumination pattern, such as in a manner selected by the user, based on sensor data 550 received from one or more sensors on board the collar.

To this point, exemplary aspects of the invention have been shown and described. It is recognized, however, that departures may be made and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group comprising A, B, C . . . and N, the text should be interpreted as requiring only one element from the group, not A plus N, or B plus N, etc.

1. A pet animal collar, comprising:
a processor unit configured to effect illumination patterns comprising a combination of color and blink for an array of light sources on the pet animal collar;
a memory unit configured to store a plurality of illumination patterns; and
a radio receiver unit configured to provide a user with wireless remote access to the processor unit for selecting at least one illumination pattern.

2. The pet animal collar recited in claim 1, wherein the processor unit comprises a microprocessor and an LED micro-controller.

3. The pet animal collar recited in claim 1, wherein the processor unit is configured to effect an illumination pattern uploaded via the radio receiver.

4. The pet animal collar recited in claim 1, wherein the processor unit is configured to transmit sensor data via the radio receiver unit to the user.

5. The pet animal collar recited in claim 1, wherein the radio receiver unit comprises at least one of a WiFi receiver, a cellular telephone receiver, and a peer-to-peer radio receiver.

6. The pet animal collar recited in claim 1, further comprising at least one sensor unit, wherein the processor unit is configured to receive as inputs, sensor signals from the sensor unit, the processor unit employing the sensor signals for changing a displayed illumination pattern.

7. The pet animal collar recited in claim 6, wherein the at least one sensor unit comprises an accelerometer.

8. The pet animal collar recited in claim 1, wherein the radio receiver unit is configured to search for and connect to an open WiFi network.

9. The pet animal collar recited in claim 8, wherein the processor unit is configured to activate a geo-location function to determine a geographic location of the WiFi network and transmit the geographic location to the user.

10. The pet animal collar recited in claim 1, wherein the processor unit is configured to activate a signaling illumination pattern to signal the user when a user-selected processing condition is met.

11. A method, comprising:
providing for effecting illumination patterns comprising a combination of color and blink for an array of light sources on a pet animal collar;
providing for storing at least one illumination pattern in a computer-readable memory; and
providing for wireless remote access to the memory to enable a user to select the at least one illumination pattern.

12. The method recited in claim 11, further comprising transmitting sensor data to the user via the wireless remote access.

13. The method recited in claim 11, wherein effecting the illumination patterns comprises changing a displayed illumination pattern based on sensor signals.

14. The method recited in claim 13, wherein the sensor signals comprise accelerometer data signals.

15. The method recited in claim 11, further comprising searching for and connecting to an open WiFi network.

16. The method recited in claim 11, further comprising activating a geo-location function to determine a geographic location of a WiFi network and transmitting the geographic location to the user.

17. The method recited in claim 16, further comprising employing a plurality of geographic location data points to track the pet animal collar.

18. The method recited in claim 11, further comprising activating a predetermined illumination pattern to signal the user when a user-selected processing condition is met.

19. A non-transitory computer readable storage medium having computer readable code thereon, the medium comprising instructions to perform the method recited in claim 11.
